(19) United States
(12) Patent Application Publication
(10) Pub. No.: US 2005/0285844 A1
(43) Pub. Date: Dec. 29, 2005

(54) 3D display system and method

(75) Inventors: Mark M. Morita, Arlington Heights, IL (US); Steven L. Fors, Chicago, IL (US); Khal A. Rai, Round Lake, IL (US)

Correspondence Address: GE MEDICAL SYSTEM;C/O FOLEY & LARDNER, 777 EAST WISCONSIN AVENUE, MILWAUKEE, WI, 53202-5367, US

(73) Assignee: GE Medical Systems Information Technologies, Inc.

(21) Appl. No.: 10/879,806

(22) Filed: Jun. 29, 2004

(51) Int. Cl. G09G 5/00

(52) U.S. Cl. 345/156

(57) ABSTRACT

An apparatus configured to display 3D volumetric data acquired from a patient by an imaging system comprises a 3D volumetric display system configured to generate a 3D diagnostic display of the 3D volumetric data. The 3D volumetric display system includes a graphical user interface (GUT) configured to permit a user to access, view, and manipulate the 3D volumetric data. The GUI includes a haptic toolbox having a plurality of icons, one of which is configured to permit the user to conduct measurement in a virtual-reality environment.

### FIELD OF THE INVENTION

This invention relates to three dimensional (3D) display systems and more particularly, to a 3D volumetric display system and method of assisting medical diagnostic interpretation of images and data in a virtual-reality environment.

### BACKGROUND OF THE INVENTION

There are many medical imaging systems used to acquire medical images suitable for diagnosing disease or injury. These include X-ray, CT scanner, magnetic resonance imaging (MRI), ultrasound, and nuclear medicine systems. These medical imaging systems are capable of acquiring large amounts of image data during a patient scan. The medical imaging devices are generally networked with a central image management system, such as Picture Archiving and Communication System (PACS).

In most cases, the image data is acquired as a series of contiguous two-dimensional (2D) slice images for diagnostic interpretation. For example, 100 to 1000 2D images may be acquired and viewed one at a time by scrolling through all the 2D images by the physician to diagnose the disease or injury. As a result, the physician is faced with the formidable task of viewing all the acquired 2D images to locate the region of interest where the disease or injury has occurred and then to select the diagnostically most useful images. As the image data sets get larger, this method of scrolling through the 2D images using a computer mouse by the physician and viewing each image becomes very time consuming and monotonous.

What is needed therefore is a system and method to improve diagnostic process and workflow through advanced visualization and user-interface technologies. What is also needed is a system and method of conducting diagnostic interpretation of the image data in a virtual-reality environment. What is also needed is a system and method of interacting with a patient's anatomy to conduct diagnostic interpretation of the image data by using tactile feedback on a variety of anatomical structures. What is also needed is a system and method of enabling a physician to contact and to manipulate the images for diagnosing anomalies in the virtual-reality environment. What is also needed is a graphical user interface (GUI) to permit an operator to use his/her hands to interactively manipulate virtual objects. These improvements would give physicians an ability to quickly navigate through a large image data set and would provide more efficient workflow. It should be understood, of course, that embodiments of the invention may also be used to meet other needs in addition to and/or instead of those set forth above.

### BRIEF SUMMARY OF THE INVENTION

In accordance with a preferred first aspect of the invention, an apparatus configured to display 3D volumetric data acquired from a patient by an imaging system is provided. The apparatus comprises a 3D volumetric display system configured to generate a 3D diagnostic display of the 3D volumetric data. The 3D volumetric display system includes a graphical user interface (GUI) configured to permit a user to access, view, and manipulate the 3D volumetric data. The GUI includes a haptic toolbox having a plurality of icons, one of which is configured to permit the user to conduct measurement in a virtual-reality environment.

In accordance with another preferred aspect of the invention, a diagnostic apparatus comprises a display system configured to generate a stereoscopic image acquired from a patient by an imaging system. The display system includes a GUI configured to be accessed simultaneously in a picture archiving and communication system (PACS) and an image workstation and to navigate through the stereoscopic image. The GUI comprises a haptic toolbox having a measurement tool. The measurement tool is configured to permit a user to conduct measurement and to display the measurement with a 3D image annotation in a virtual-reality environment.

In accordance with a further preferred aspect of the invention, a method of assisting diagnostic interpretation of a stereoscopic image in a virtual-reality environment is provided. The method comprises receiving a user input associated with a GUI to conduct measurement in the virtual-reality environment, generating a haptic toolbox from the GUI, measuring a patient's anatomy by using the virtual measurement tool, and displaying a 3D haptic annotation by using the haptic toolbar to illustrate the measurement of the patient's anatomy. The haptic toolbox comprises a measurement tool.

In accordance with yet a further preferred aspect of the invention, a system configured to display a stereoscopic image in a virtual-reality is provided. The system comprises means for permitting a user to conduct measurement of patient anatomy in a virtual-reality environment and for displaying an image annotation when conducting measurement of the patient anatomy in the virtual-reality environment.

### BRIEF DESCRIPTION OF THE DRAWINGS

FIG. 1 is a block diagram of a 3D volumetric display system which employs an embodiment of the present invention;

FIG. 2 is an implementation of the 3D volumetric display system shown in FIG. 1 in a virtual reality environment;

FIG. 3 is a portion of FIG. 2 illustrating a plurality of 2D images in the virtual reality environment;

FIG. 4 is a haptic tool configured to be positioned within a stereoscopic image to display a cross-sectional image of an anatomical structure of a patient's body;

FIG. 5 is a 3D Computer-Aided Diagnosis (CAD) marker configured to be used in a stereoscopic image to indicate likelihood of an anomaly in the anatomical structure of a patient's body;

FIG. 6 is a haptic toolbox having a plurality of icons in which one of the plurality of icons is a measurement tool that is in an open position; and

FIG. 7 is a 3D image annotation by using the measurement tool in FIG. 6 in a virtual reality environment.

### DETAILED DESCRIPTION OF PREFERRED EMBODIMENTS

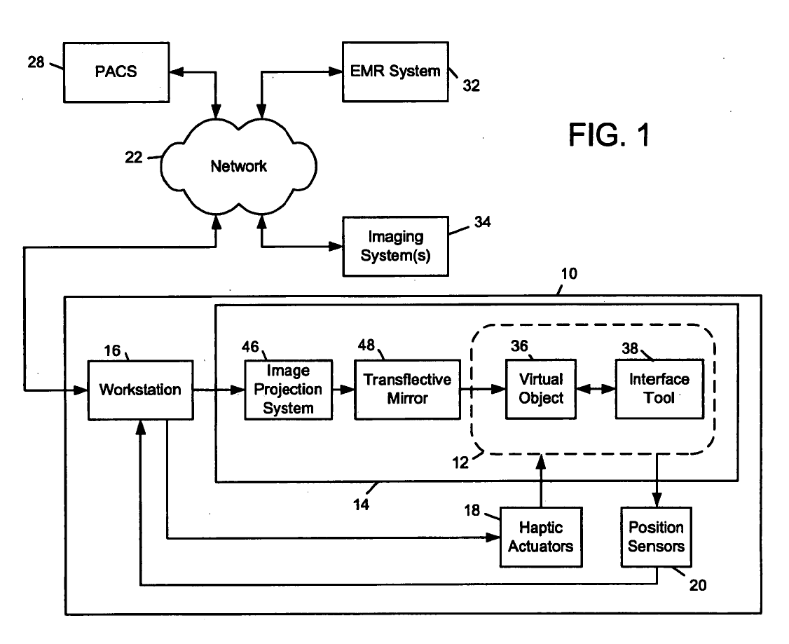

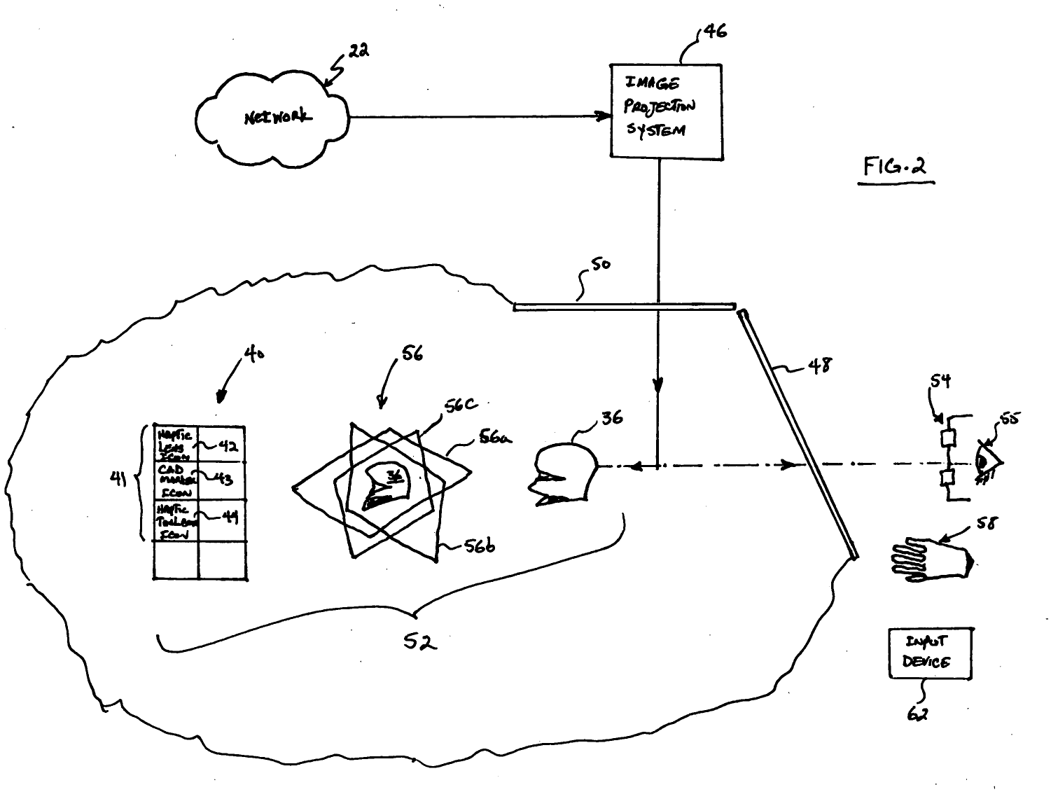

FIGS. 1 and 2 illustrate a 3D volumetric display system 10 which implements a virtual-reality environment 12. The 3D volumetric display system (hereinafter “display system”) 10 includes a haptics-enhanced virtual-reality system 14, a workstation 16, a plurality of haptic actuators 18, and a plurality of position sensors or trackers 20. The display system 10 may be coupled by way of a network 22 to receive data from, among others, a picture archival and communication system (PACS) 28, an electronic medical records system 32, and one or more imaging systems 34. Although not shown, the PACS 28, the electronic medical record (EMR) system 32, and the imaging system 34 may each comprise or be associated with one or more additional workstations, networks/sub-networks, and so on.

The haptics-enhanced virtual-reality system 14 is driven by the workstation 16 to display stereoscopic images 52 so that a user can touch and interact with a virtual object 36, i.e., an anatomical structure of a patient's body. The images may be received by the workstation 16 from the PACS 28, which stores images received from the imaging systems 34. Alternatively, the images may be received directly from one of the imaging systems 34, e.g., to allow a virtual examination of the patient's anatomy during a minimally-invasive surgical procedure. Haptic feedback is provided to the operator using the haptic actuators 18 and which apply forces to a user's hands and fingers. The haptic feedback may assist and inform the user of interactions and events within the virtual reality environment 12. The plurality of haptic actuators 18 and the plurality of position sensors or trackers 20 are connected to the workstation 16 to permit interaction in the virtual-reality environment 12. The actuators 18 and the trackers 20 may be mounted to a common user interface device, such as one or more haptic gloves 58 (see FIG. 2), such that the trackers 20 provide information to the workstation 16 regarding the position of the operator's hands and fingers, while at the same time the actuators 18 apply forces to the user's hands and fingers to provide a haptic sensation to the user of contacting the virtual object 36 (in accordance with the known position of the user's hands and fingers within the virtual reality environment 12). Control signals for the haptic actuators 18 are generated by the workstation 16 based not only on the position of the user's hands and fingers, but also based on the known anatomical structure of the patient as represented in the image data received from the PACS 28 and/or the imaging systems 34.

Each imaging system 34 may include an acquisition workstation (not shown) which acts as a gateway between the imaging systems 34 and the network 22. To that end, the acquisition workstation may accept raw image data from the imaging systems 34 and optionally perform pre-processing on image data in preparation for delivering image data to the PACS network 28 for storage in a PACS image database (not shown). In operation, the acquisition workstation (not shown) may convert the image data into DICOM, DEFF, or other suitable format.

The display system 10 is configured to generate 3D diagnostic displays of 3D volumetric medical data network 22 acquired from a patient by one or more of the imaging systems 34. The 3D displays are generated in the virtual-reality environment 12. The display system 10 permits a user, such as a physician or radiologist, to conduct diagnostic interpretation of images in the virtual reality environment 12 and to interact with the 3D diagnostic displays. The imaging systems 34 may include, but are not limited to, magnetic resonance imaging devices, computed tomography (CT) devices, ultrasound devices, nuclear imaging devices, X-ray devices, and/or a variety of other types of imaging devices. It should be understood that imaging systems 34 are not limited to medical imaging devices and also include scanners and imaging devices from other fields.

As shown in FIGS. 1 and 2, the display system 10 includes a graphical user interface (GUI) that is configured to permit a user to interact with the 3D diagnostic displays generated by the display system 10. The GUI comprises an interface tool 38 which may be customized by the user. In addition, the GUI comprises a tool palette window 40 to display a plurality of toolbar icons 41. The tool palette window 40 includes, but is not limited to, a haptic tool icon 42, a 3D Computer-Aided Diagnosis (CAD) marker icon 43, a haptic toolbox icon 44, and a variety of other icons (not shown) such as an image mask icon, a magnify icon, a horizontal flip icon, a vertical flip icon, a pan icon, a zoom icon, and so on. As will be described in greater detail, each of the icons 41 is configured to permit the user to interact with the 3D diagnostic display. The GUI is configured to navigate through diagnostic image data without post-processing of the diagnostic images. Post-processing refers to image manipulation processing that happens after the image/data is acquired from the modalities (e.g., CT, MR, and so on). For example, one type of post-processing that may be avoided is segmenting, which is a type of post processing used for 3D visualization. With segmenting, extraneous anatomical structure around a structure of interest is removed in order to facilitate examination of the structure of interest. This allows the isolation of a particular anatomical system from the extraneous systems, for example, so that a radiologist would be able to visualize just the veins and arteries while looking for an aneurysm. Other examples of post processing include temporal subtraction for CR images, dual energy subtraction for CR images, and TE algorithm processing for CR mammography images. With on the fly 3D capabilities, many post processing applications can be done on the fly in real time. The GUI enables the user to access, view, manipulate, and conduct diagnostic interpretation of the images. The user interface is provided in the virtual reality environment 16.

It will be appreciated that, although the interface tool (GUI) 38 is shown as being located in the virtual reality environment 12, the GUI is actually implemented by program logic stored and executed in the workstation 16. The workstation 16 receives feedback information from the position sensors 20 and processes the feedback information (in accordance with the stored program logic and in accordance with the stored image data received via the network 22) to drive the haptic actuators 18 and to drive the image projection system 46 (e.g., to alter the GUI display and/or to alter the displayed image data).

As shown best in FIG. 2, the haptics-enhanced virtual-reality system 14 includes an image projection system 46, a transflective (i.e., partially transparent and partially reflective) mirror 48 positioned at an angle, and an overhead substantially opaque screen 50, which cooperate to display stereoscopic images 52. The stereoscopic images 52 are projected on the overhead substantially opaque screen 50 and are reflected on the transflective mirror 48. The operator is able to interact with the 3D/4D image data (virtual object 36) in real time. That is, when the operator places a hand at a location that places the operator's hand into virtual contact with anatomical structure, the GUI provides tactile feedback to the operator's hand via the haptic actuators 18 sufficiently fast such that processing delay is substantially imperceptible to the user. The 3D/4D image data refers to three spatial dimensions and time as the fourth dimension. The stereoscopic images 52 are viewed by the user wearing 3D goggles 54. The 3D goggles may include infrared sensors which track the position and orientation of the goggles 54, and by that means, the position and orientation of the viewer's eye. The infrared sensors transmit the position and orientation information to the workstation 16 which uses the position and orientation information to determine the point of view and viewing direction from which the viewer is viewing the virtual objects. This permits the stereoscopic images 52 to be displayed in a manner that shows the virtual-reality environment 12 as it would be seen from the point of view and viewing direction indicated by the position and orientation information. The stereoscopic images 52 are displayed such that the displayed images track the user's head movement and permit the user to view the imagery from more than one position. The user's hand is in contact with the displayed images and the user is provided with the ability to manipulate and navigate through the 3D diagnostic displays to locate pathology in the virtual-reality environment 12. For example, virtual colonoscopy has become a true reality in medicine with advances in CT and Electron Beam Tomography (EBT). Using the aforementioned technique, it is now possible to conduct diagnosis of the entire colon without sedatives, excessive discomfort, or truly invasive procedures. The virtual colonoscopy makes colon cancer screening more bearable.

While the stereoscopic images 52 provide sufficient information to conduct diagnostic interpretation of the 3D images, many physicians or radiologists prefer to see 2D sectional images taken through the region of interest within the anatomical structure of the patient's body. Such 2D sectional images are often presented as three orthogonal planes including transverse, sagittal, and coronal images 56a, 56b, 56c respectively, depending on their orientation with respect to the patient. Thus, using the 3D diagnostic display to identify a region of interest in the patient, as shown in FIG. 2, a 3D planner image 56 is constructed from the 2D images such as 56a, 56b, 56c to facilitate measurement of the diagnostic interpretation of images for anomalies. The display system 10 enables the user to view and interact with the 3D planner images 56 and 3D diagnostic display simultaneously.

As mentioned above, the display system 10 comprises the haptic actuators 18 which have robotic manipulators (not shown) that apply force to the user's hand corresponding to the environment that a virtual effector (i.e., muscles become active in response to stimulation) is in. The haptics feedback is used to indicate whether the user's hand is in contact with the anatomical structure of a patient's body 36. As previously mentioned, the display system 10 includes haptic glove 58 upon which the haptic actuators 18 are mounted and which is configured to be worn by the user to provide the tactile sensation to the hand of the user to simulate contact with the virtual object 36. The haptic glove 58 provides a sense of touch in the virtual reality environment 12. For example, if a user tries to grab the virtual object 36, the haptic glove 58 provides feedback to let the user know that the virtual object 36 is in contact with the user's hand. Also, the haptic glove 58 provides a mechanism to keep the user's hand from passing through the virtual object 36.

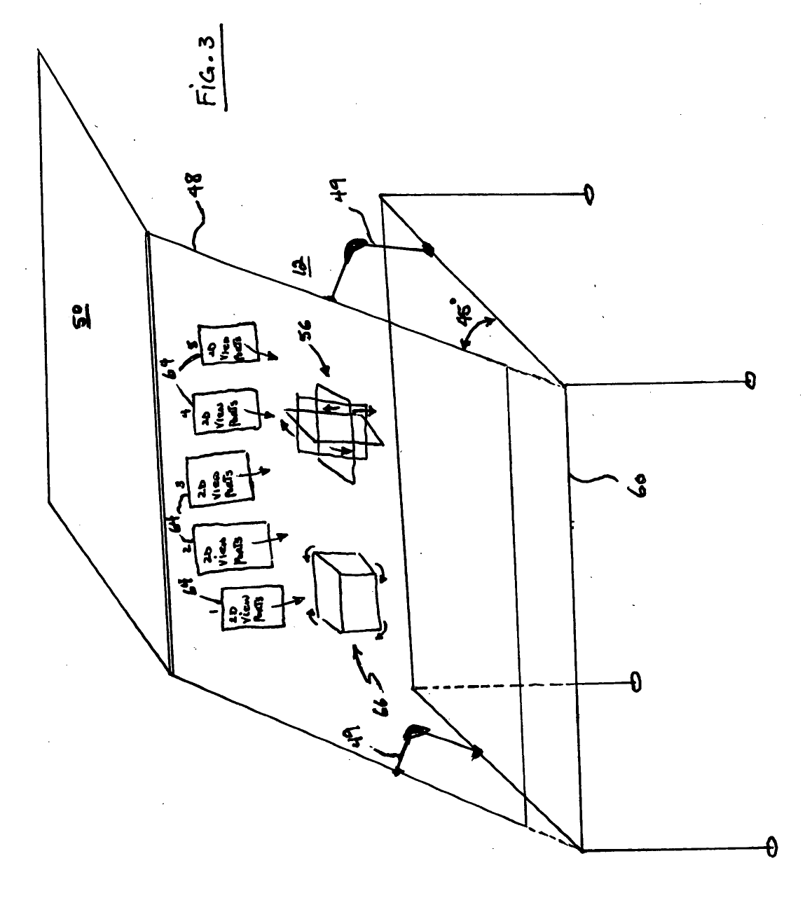

Referring to FIG. 3, the projection-based display or the virtual-reality environment 12 includes transflective mirror 48 mounted to table 60 with a pair of hinges 49. The transflective mirror 48 is positioned at an angle, preferably 45 degrees, in front of the user. The overhead substantially opaque screen 50 is positioned above the table 60 to superimpose virtual imagery on a physical object, such as a user's hand, below it. The overhead substantially opaque screen 50 is supported by hangers (not shown). The image projection system 46 and the transflective mirror 48 are employed to compactly and brightly illuminate the overhead substantially opaque screen for brilliant contrast. Images projected on the opaque screen 50 are reflected on the transflective mirror 48 positioned over the table 60. Generally, since the user wearing the 3D goggles 54 is standing in front of the transflective mirror 48, the virtual-reality environment 12 behind the transflective mirror 48, when displayed and reflected, has to change in such a way that appears stereoscopically correct. Therefore, when the user puts his or her hands under the transflective mirrored area, the user can see and interact with the virtual image, or the physical haptic devices. A variety of input devices 62, such as haptic stylus, wand and voice commands, can be used in combination to manipulate, modify and examine virtual objects, and interact with other visualized data. This configuration is well suited to the lighting conditions of a typical office environment, and the haptics-enhanced virtual-reality system 14 can be easily packed, moved, and deployed. The transflective mirror 48 can be raised or lowered over the table so the users can either work at their table or in the virtual-reality space.

During imaging of a subject of interest, such as a portion of an anatomical structure of a patient's body 36, one or more of the imaging systems 34 are used to acquire a plurality of 2D images of the subject interest. The PACS 28 archives the plurality of 2D images so they can be selectively retrieved and accessed. Other patient data may also be retrieved, such as electronic medical record data which may be retrieved from the EMR system 32. The plurality of 2D images and/or the patient's medical record is then displayed in the form of 2D viewports 64 in the virtual reality environment 12. The display system 10 is capable of displaying the 2D images 64, 3D planner images 56, and volumetric 3D diagnostic images 66 simultaneously as best shown in FIG. 3. This feature permits a physician or radiologist to easily navigate through the 3D diagnostic images to locate pathology without having to necessarily read each and every one of the 2D images. Once the pathology or area of interest is identified, the physician or radiologist may click on the area of interest within the 3D diagnostic images 66, and the corresponding 3D planner images 56 will update the exact reference point.

The cubical model in FIG. 3 represents the volumetric 3D diagnostic image 66 or a 3D data set. The 3D diagnostic image 66 can be manipulated in any orientation, angle, zoom setting and so forth. In addition, for the 3D diagnostic image 66, transparency and segmentation may also be defined such that the physician or radiologist is permitted to view a variety of anatomical structures of the patient. As noted above, when the user is wearing the 3D goggles 54, the workstation 16 is able to conduct the head tracking and provide stereoscopic visualization of the images. When the user moves his head, an updated view of the 3D diagnostic image 66 is displayed. Additionally, when the user rotates the cubical model, the corresponding 3D planner image 56 orients in synchronization. Further, when the user clicks on a specific part of the anatomy depicted as the cubical model 66, the corresponding planner images 56 and the viewports 64 are instantly updated. This practice permits physicians or radiologists to conduct diagnostic interpretation of the images without scrolling though the datasets examining each image. Since this practice is conducted in the virtual-reality environment 12, as described above, the user is provided with the haptics actuators 18 which permit the user to actually feel tactile differences in the anatomical data.

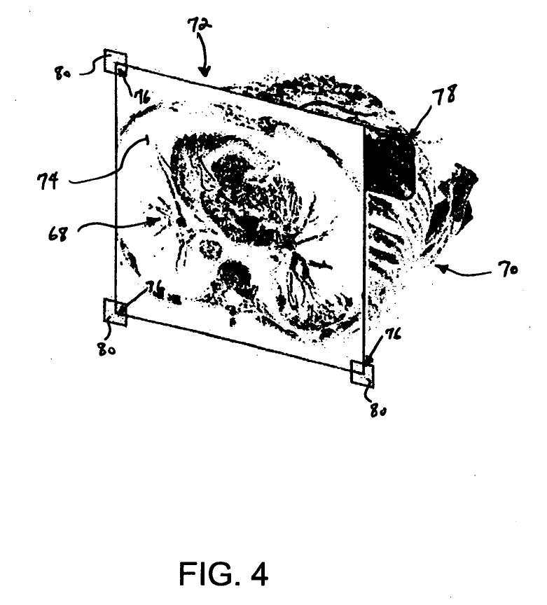

FIG. 4 is the haptic tool icon 42 of the tool palette window 40 shown in FIG. 2. The haptic tool icon 42 is configured to be positioned within a stereoscopic image to display a cross-sectional image 68 of an anatomical structure of a patient's body 70 in the virtual-reality environment 12. As mentioned above, the GUI of the 3D display system 10 comprises the haptic tool 72 having a virtual lens 74 configured to navigate through the stereoscopic image to generate a cross-sectional image 68 of the anatomical structure of a patient's body 70 in the virtual-reality environment 12. The virtual lens 74 comprises a plurality of corners 76 spaced apart from one another to encapsulate the virtual anatomical structure of a patient's body 70. The haptic tool 72 is displayed with the haptics-enhanced virtual-reality system 14. The haptic tool 72 provides an intuitive way for navigating through the data set and conducting diagnostic interpretation of the virtual anatomical structure of a patient's body 70.

The haptic tool 72 comprises a virtual handle 78 attached to one of the plurality corners 76 of virtual lens 74 to permit a user to navigate through the anatomical structure of a patient's body 70. The virtual handle 78 is configured to be held by the user wearing the haptic glove 58 when the haptic tool 72 is navigated through the virtual anatomical structure of a patient's body 70. The haptic actuators 18 in FIG. 1 are configured to provide a tactile feedback regarding contact between the user's hands with the anatomical structure of a patient's body 70. Since the user is wearing the haptic glove 58, the haptic actuators 18 outputs a pressure to the haptic glove 58 which is felt by the user's sense of touch. The tactile feedback sensation that the user feels is generated by the haptic glove 58.

The haptic tool 72 further comprises a virtual tab 80 disposed on at least two of the plurality of corners 76 of the virtual lens 74. The virtual tabs 80 permit the user to change the dimensional size and orientation of the haptic tool 72 within the virtual anatomical structure of a patient's body 70. The haptic tool is capable of depicting the cross-sectional image 68 that is characterized by combination of three orthogonal planes including transverse, sagittal, and coronal planes as depicted by 56a, 56b, and 56c respectively. The haptic tool 72 is configured to be positioned at various orientations and angles with respect to the virtual anatomical structure of a patient's body 70 to generate the cross-sectional image 68 within stereoscopic image. For example, the haptic tool 72 is capable of displaying a cross-sectional image that is configured to be constructed from a combination of transverse, sagittal, and coronal images. In operation, when the haptic tool 72 is navigated through the stereoscopic image responsive to user inputs, coordinates of the haptic tool 72 are mapped with a boundary of the virtual anatomical structure of a patient's body 70 to generate the cross-sectional image 68 and then the cross-sectional image is displayed to permit a diagnostic interpretation of the image to be conducted.

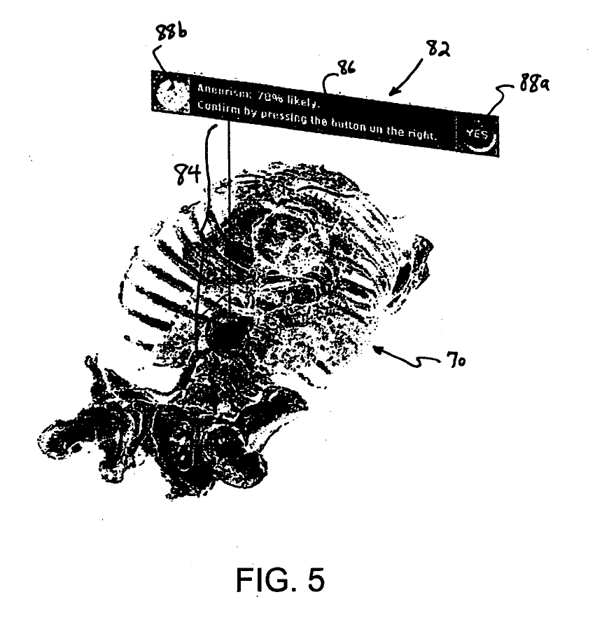

FIG. 5 is a 3D CAD marker icon 43 of the tool palette window 40 shown in FIG. 2. The 3D CAD marker 82 has a delineator 84 configured to be navigated in the anatomical structure of a patient's body 70 to locate a pathology or anomaly and to permit the user to compile and prepare a report containing diagnosis information in a virtual-reality environment 12. The delineator 84 includes a 3D delineator having a boundary that defines a perimeter of the anomaly. The 3D CAD marker 82 is displayed with the haptics-enhanced virtual-reality system 14. In FIG. 5, there is shown just one 3D CAD marker 82 but, alternatively, a plurality of 3D CAD markers may be used to navigate in a virtual anatomical structure of a patient's body 70 to locate a pathology or anomaly.

The 3D CAD marker 82 includes a status indicator 86 which is associated with the delineator 84 to display diagnosis information in the virtual-reality environment. The status indicator 86 comprises a plurality of command buttons configured to receive a user input to compile the diagnostic report. The plurality of command buttons comprises first and second buttons (e.g., YES and NO command buttons) 88a & 88b, respectively. The YES command button 88a is configured to receive a user input to accept diagnosis information, e.g., responsive to the user pressing the YES command button 88a. The NO command button 88b is configured to receive a user input to discard unwanted diagnosis information, e.g., responsive to the user pressing the NO command button 88b. When the user wearing the haptic glove 58 contacts the YES or NO button, the position of the user's hand is detected using the position sensors 20 and in turn, the workstation 16 produces an activating signal to drive the haptic actuators 18 for outputting forces to the user's hand.

During operation, the user wears the haptic glove 58 while holding the 3D CAD marker 82 and the 3D CAD marker is navigated through the stereoscopic image or the virtual anatomical structure of a patient's body 70 by the workstation 16 responsive to the user inputs. The 3D CAD marker 82 indicates the likelihood of an anomaly in the stereoscopic image of a patient by using the delineator 84 and displays diagnosis information about the anomaly in the status bar 86. Finally, upon receiving the user input using the command buttons 88a, the display system generates a report containing the diagnosis information in the virtual-reality environment 12. The 3D CAD marker 82 includes a color code feature which enables a user to display diagnosis information in various colors within the GUI.

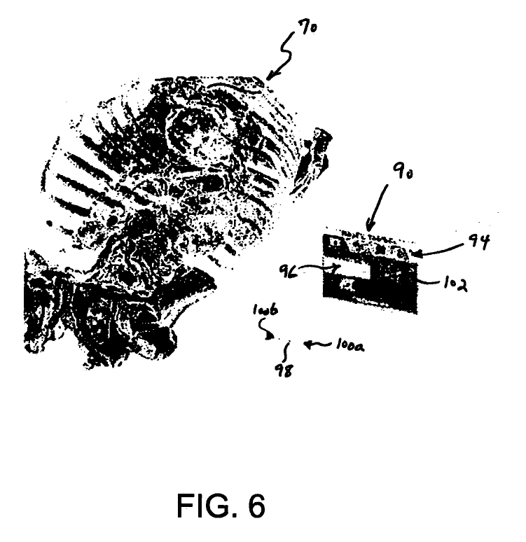

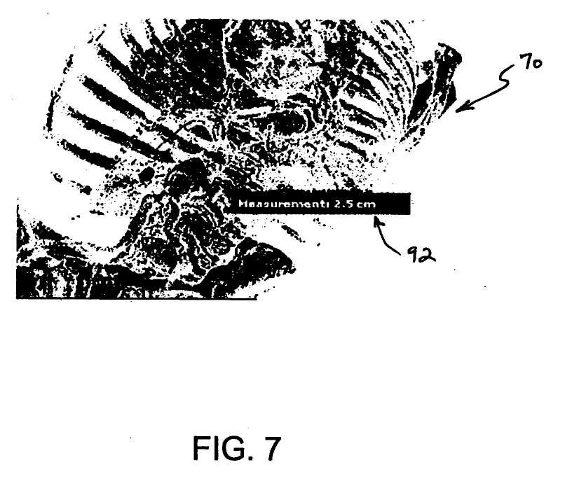

FIGS. 6 and 7 illustrate a haptic toolbox 90 and a 3D image annotation 92 respectively, in the virtual-reality environment 12. The haptic toolbox 90 includes a plurality of icons 94. One of the plurality of icons includes a linear measurement tool 96 that is configured to permit a user to conduct measurements in the virtual-reality environment. The measurement tool 96 includes a rod 98 having an opposed ends 100. The opposed ends are generally triangular in shape. The measurement tool 96 is configured to be linearly extended or contracted corresponding to a given size of the patient's anatomy. When the measurement tool 96 is placed on the patient's anatomy by the user wearing the haptic glove 58, the measurement tool 96 uses an algorithm for edge detection executed within the display system 10 to measure the linear dimension of the patient's anatomy. The plurality of icons further include nonlinear measurement icons such as angular measurement 102, zoom icon, text icon, and a variety of other icons that are touchable by the user in the virtual-reality environment.

During operation, the display system 10 receives a user input associated with GUI to conduct measurement in the virtual-reality environment 12. The user wearing the haptic glove 58 clicks on the haptic toolbox icon 44, located in the tool palette window 40 shown in FIG. 2, and the haptic toolbox 90 pops up. Next, the user clicks on the measurement tool icon 96 and the measurement tool 96 pops up. The user then grabs the measurement tool 96 and places it on the patient's anatomy to measure thereof and displaying a 3D haptic annotation 92 to illustrate measurement of the patient's anatomy as clearly depicted in FIG. 7. If the length or width of the patient's anatomy is different from the measurement tool, then the user may hold the triangular corners 100a and 100b while extending or contracting the measurement tool 96. When the edges of the triangular corners 100a and 100b coincide with the edges of the patient's anatomy 70, the display system generates a text and numeric indicium “measurement 2.5 cm” and displays the image annotation 92 in the virtual-reality environment 12.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An apparatus configured to display 3D volumetric data acquired from a patient by an imaging system, the apparatus comprising:
a 3D volumetric display system configured to generate a 3D diagnostic display of the 3D volumetric data, the 3D volumetric display system including a graphical user interface configured to permit a user to access, view, and manipulate the 3D volumetric data, the graphical user interface including a haptic toolbox having a plurality of icons, one of the plurality of icons is configured to permit the user to conduct measurement in a virtual-reality environment.

2. The apparatus of claim 1; wherein the 3D volumetric display system includes a haptics-enhanced virtual-reality system, and wherein the haptic toolbox is displayed with the haptics-enhanced virtual-reality system.

3. The apparatus of claim 1, wherein the haptics-enhanced virtual-reality system comprises a projector, a transflective mirror positioned at an angle, and an overhead substantially opaque screen, which all are coupled to one another to display a stereoscopic image that is projected on the overhead substantially opaque screen and is reflected in the 3D volumetric data on the transflective mirror.

4. The apparatus of claim 1, wherein the haptic toolbox is configured to produce 3D haptic annotation in the virtual reality environment.

5. The apparatus of claim 1, wherein the one of the plurality of icons includes a measurement tool comprises a rod having an opposed ends.

6. The apparatus of claim 5, wherein the display system further comprises a haptic glove configured, to be worn by the user and wherein the measurement tool is configured to be held in the virtual-reality environment by a hand of the user wearing the haptic glove and to be positioned on a patient's anatomy to conduct measurement.

7. The apparatus of claim 5, wherein the measurement tool is configured to be linearly extended or contracted corresponding to a given size of the patient's anatomy.

8. The apparatus of claim 5, wherein the opposed ends of the rod are generally triangular in shape.

9. The apparatus of claim 6, wherein the haptic glove includes an actuator configured to output a tactile sensation to the hand of the user wearing the haptic glove in the virtual-reality environment.

10. The apparatus of claim 9, wherein the actuator outputs a force to the haptic glove to provide the tactile sensation to the hand of the user to simulate contact with the haptic toolbar.

11. The apparatus of claim 9, wherein the actuator output the force to the haptic glove based on force information output by the 3D display system.

12. A diagnostic apparatus comprising:
a display system configured to generate a stereoscopic image acquired from a patient by an imaging system, the display system including a graphical user interface configured to access simultaneously in a picture archiving and communication system (PACS) and an image workstation and to navigate through the stereoscopic image, the graphical user interface comprising a haptic toolbox having a measurement tool, the measurement tool being configured to permit a user to conduct measurement and to display the measurement with a 3D image annotation in a virtual-reality environment.

13. The apparatus of claim 12, wherein the graphical user interface is configured to access, view, and manipulate the stereoscopic image.

14. The apparatus of claim 12, wherein the display system is a haptics-enhanced virtual-reality display system so that the user can conduct measurements and interact with the haptic toolbar.

15. The apparatus of claim 12, wherein the haptic toolbox comprises a plurality of icons including image and text icons touchable by the user in the virtual-reality environment.

16. The apparatus of claim 12, wherein the measurement tool is configured to be linearly extended or contracted corresponding to a given size of a patient's anatomy.

17. The apparatus of claim 16, wherein the measurement tool uses an algorithm for edge detection executed within the display system to measure the linear dimension of the patient's anatomy.

18. The apparatus of claim 12, wherein the display system further comprises a haptic glove configured to be worn by the user and wherein the measurement tool is configured to be held by a hand of the user wearing the haptic glove and to be positioned on a patient's anatomy to conduct measurements.

19. A method of assisting diagnostic interpretation of a stereoscopic image in a virtual-reality environment, the method comprising the steps of:
receiving a user input associated with a graphical user interface to conduct measurements in the virtual-reality environment;
generating a haptic toolbox from the graphical user interface, the haptic toolbox comprising a measurement tool;
measuring a patient's anatomy by using the virtual measurement tool; and
displaying a 3D haptic annotation by using the haptic toolbar to illustrate the measurement of the patient's anatomy.

20. The method of claim 19, wherein the step of receiving a user input includes wearing a haptic glove by the user to interact with the graphical user interface.

21. The method of claim 19, wherein the haptic toolbox comprises a plurality of icons including image and text icons touchable by the user wearing the haptic glove in the virtual-reality environment.

22. The method of claim 19, wherein the step of measuring a patient's anatomy includes linearly extending or contracting the measurement tool corresponding to a given size of the patient's anatomy while the user is wearing the haptic glove and holding the measurement tool.

23. The method of claim 22, wherein the step of measuring the patient's anatomy includes using an algorithm for edge detection for linearly aligning edges of the measurement tool with the edges of the patient's anatomy.

24. A system configured to display a stereoscopic image in a virtual-reality environment, the system comprising:
means for permitting a user to conduct measurements of patient anatomy in the virtual-reality environment; and
means for displaying an image annotation when conducting measurements of patient anatomy in the virtual-reality environment.
